(19) United States
(12) Patent Application Publication
(10) Pub. No.: US 2008/0276470 A1
(43) Pub. Date: Nov. 13, 2008

(54) Reciprocating Saw and Attachments

(76) Inventors: Jon Ritter, Cazadero, CA (US); Rebecca Ritter, Cazadero, CA (US)

Correspondence Address: GREENBERG & LIEBERMAN, LLC, 2141 WISCONSIN AVE, N.W., SUITE C-2, WASHINGTON, DC, 20007, US

(21) Appl. No.: 11/813,983

(22) PCT Filed: Jan. 18, 2006
(86) PCT No.: PCT/US2006/001386

§ 371 Date: Mar. 31, 2008

(30) Foreign Application Priority Data
Jan. 18, 2005 (US) 11/037888

(51) Int. Cl. B27B 19/00; B27B 23/00

(52) U.S. Cl. 30/392; 30/514

(57) ABSTRACT

A simple attachment for a reciprocating tool that will effectuate the ability to do a flush cut in an inexpensive and simple manner which is neither' too ligid, nor not rigid enough. This is effectuated by providing an insert, which fits into the reciprocating tool in the same fashion as a regular' blade. The present invention then offsets the placement of a blade, sander, file, or' other 1 tool by as many inches as wished by the user 1. The blade, sander, file, or other tool is held rigid through the use of a 45 degree bracket spanning the distance from the original plane to the offset plane, or via a single or compound trapezoid design.

Priority is hereby claimed to U.S. patent application No. 60/481,864 filed on Jan. 6, 2004, as well as PCT/US04/09432 Mar. 30, 2004

### FIELD OF THE INVENTION

The present invention relates to an attachment for reciprocating tools, such as reciprocating saws. More particularly, the present is an offset attachment that permits a reciprocating tool to be fit with a variety of blades, sanders, and the like to attack a point from an offset angle.

### BACKGROUND OF THE INVENTION

Conventional reciprocating tools allow the user to attack a point straight on, or in other words, in a direct line from the tip of the reciprocating tool to the point. While a typical blade can be affixed in the center of the reciprocating tool, the body of the reciprocating tool oftentimes interferes with the surfaces around a point of attack.

For example, if a user wants to use a reciprocating tool to cut a two-inch by two-inch section in a dry wall area so that the two inch by two inch section is adjacent to a floor, the user cannot easily do so with a reciprocating tool. Because the saw blade extends out of the center front of the reciprocating tool, and the reciprocating tool has a bulky mass, the user can only make such a cut into the drywall at an angle away from ninety degrees. The best way to cut into the drywall is to maintain the saw blade perpendicular to the dry wall; however, because the reciprocating tool must remain above the floor, the user must approach the drywall so that the point of attack varies from ninety degrees from the drywall. Varying from a perpendicular point of attack, the user's cut is less reliable, less controlled, and encroaches into the drywall unevenly.

Restated, the problem is that the user cannot possibly position the reciprocating tool perpendicular to the drywall because the housing of the reciprocating tool must remain above the floor. There is a need for a device that allows reciprocating tool attachments perpendicular access to spaces wherein the mass of the reciprocating tool interferes with the normal point of attack.

In the past, users have attempted to create attachments capable of making cuts near an object while maintaining a perpendicular point of attack; however, such attachments have been either not rigid enough in order to effectuate a straight cut (that is, the saw attachments bend under the pressure of the saw attachments entering the drywall), have been too rigid thereby preventing the user from completing the cut all the way into a corner (that is, the saw attachments cannot be adjusted or interchanged as access to points of attack vary), or have been so complicated that they would break—and when broken, would be very expensive to fix. Thus, there is a need for a requisitely rigid offset attachment for a reciprocating tool that can be adjusted or interchanged easily that is not so complicated that the cost is prohibitive should it become damaged.

U.S. Pat. No. 3,028,890 issued on Apr. 10, 1962, to G. E. Atkinson, et al. describes a power saw which accepts a blade in both the center position and offset on the edge of the blade holders. Atkinson's blade holder is inferior to the present invention as Atkinson's blade holder can only adjust to various positions in line with the power saw; it is ill suited to make a cut in a wall at the point where the wall touches the floor because there is very little room to maneuver the body of the power saw. Further, Atkinson's blade holder does not offer any extension of the blade forward, so that the power saw can remain a greater distance from the cut while cutting.

U.S. Pat. No. 3,260,290 issued on Jul. 12, 1966, to R. Happe, et al. describes a power saw attachment, which accepts a blade for an offset position. However, Happe's device uses a guide rod, which shortens the cut of the blade and does not allow the blade to be as flexible as desired. Further, Happe's device does not allow for different and varied blade placements and offsets.

U.S. Pat. No. 4,553,306 issued on Nov. 19, 1985 to Mineck describes a reciprocating offset blade. Although Mineck's offset blade adapter does allow for the blade to be placed in more then one position, one of which is that of the flush cut, Mineck's adapter does so through a complicated device that, once broken, is expensive to replace. Further, Mineck's adapter does not allow for different and varied blade placements and offsets, and does not extend the distance between the blade and the reciprocating tool.

Thus, there is a need for an offset tool adapter for a reciprocating tool capable of distancing offset tool attachments from the offset tool itself (i.e. adding inches onto the length of the offset tool attachment). Further, there is a need for an offset tool adapter that allows various positioning so that the angle of attack to make a cut, etc. can be altered. Also, there is a need for an offset tool adapter that allows for quick interchangeability so that various offset tool attachments can be employed in short amount of time.

### SUMMARY OF THE INVENTION

The present invention is an attachment for reciprocating tools that allows blades, sanders, or any other device associated with a reciprocating tool to be quickly interchanged. The present invention has spaces common devices for reciprocating tools in different but parallel plane to the plane of the reciprocating tool. Thus, the user can access areas typically unreachable because with the present invention, the user can hold the reciprocating tool's body in a different plane than the device attached to the reciprocating tool. The present invention preferably has a 45 degree angle shift between the plane of the reciprocating tool and tire plane of the device attached to the reciprocating tool. The angle provides a good blend of offset distance, structural integrity, and extension of the device ahead of the reciprocating tool.

Alternative embodiments of the present invention provide for rotation at the point where the reciprocating tool's body attaches to holder for a device attached to a reciprocating tool, such that the holder for the device attached to the reciprocating tool rotates for ease of use in accessing work areas. Additional embodiments of the present invention provide for rotation at the point where the device attached to a reciprocating tool attaches to blades, sanders, or any other device associated with a reciprocating tool—such that the device attached to a reciprocating tool rotates for ease of use in accessing work areas. Further embodiments of the present invention provide means to extend the reach of blade attachment with stability and strength, additional sanding paddles and a multi tool attachment. The extension may be anywhere from 2 inches to 10 feet, however the preferred length is 2 inches to 2 feet. The sanding paddles, of all shapes and sizes, are preferably made of memory plastic and that has the capability to attach sandpaper to at least one side via one of many conventional fastening means, such as glue, hook and loop or adhesive tape.

### BRIEF DESCRIPTION OF THE DRAWINGS

FIG. 1 is a right side view of a first embodiment of the present invention.

FIG. 2 is an environmental view a second embodiment of the present invention

FIG. 3 is a side view of a third embodiment of the present invention.

FIG. 4 is a side view of a fourth embodiment of the present invention.

FIG. 5 is a cross section view of a fifth embodiment of the present invention.

FIG. 6 is a cross section view of a sixth embodiment of the present invention.

FIG. 7 is a cross section view of a seventh embodiment of the present invention.

FIG. 8 is a side view of the seventh embodiment

FIG. 9 is a side view of the multi tool attachment

FIG. 10 is a side view of the extension

FIG. 11 is an environmental view of the sanding paddle attachment attached to the extension.

FIG. 12 is an environmental view of the sanding paddle.

FIG. 13 is an environmental view of the adjustable multiple attachment system.

FIG. 14 is ah environmental view of the wire brush.

FIG. 15 is an environmental view of the wire brush with attached scraper.

FIG. 16 is side view of the eighth embodiment of the present invention.

FIG. 17 is a side view of the ninth embodiment of the present invention.

FIG. 18 is a front view of the ninth embodiment of the present invention.

FIG. 19 is a front view of the dial of the ninth embodiment of the present invention.

FIG. 20 is a top view of the tenth embodiment of the present invention.

FIG. 21 is a side view of the tenth embodiment of the present invention.

FIG. 22 is a side view of a stabilization indicating rod with mounted guide.

FIG. 23 is a top view of the eleventh embodiment of the present invention.

FIG. 24 is a side view of the eleventh embodiment of the present invention.

FIG. 25 is a side view of a laser chalk line with a level.

FIG. 26 is a side view of the twelfth embodiment of the present invention.

FIG. 27 is a bottom view of the twelfth embodiment of the present invention.

FIG. 28 is a side view of the thirteenth embodiment of the present invention.

FIG. 29 is a side view of the fourteenth embodiment of the present invention.

### DESCRIPTION OF THE PREFERRED EMBODIMENT(S)

As seen in the attached drawings, the present invention is designed to be used with any power driven saw (10) having a reciprocating drive member (20). The present invention has an offset adapter (30) made up of a first, second, and third metal planes (40, 50, 60), two angle braces (70, 80), a conventional set screw (90), preferably a conventional screw that can be tightened or loosened by user with hands, and a set screw receiving member (100).

The first straight metal plane (40) is designed to insert into the reciprocating drive member (20) and has the standard hole (25) used for locking any reciprocating saw blade into a reciprocating drive member (20). The second straight metal plane (50) is disposed anywhere from 90-degrees to 45 degrees from the first metal plane (40), and the second straight metal plane (50) is correspondingly attached to the third metal plane (60) anywhere from 90-degrees to 45 degrees from the third metal plane (60).

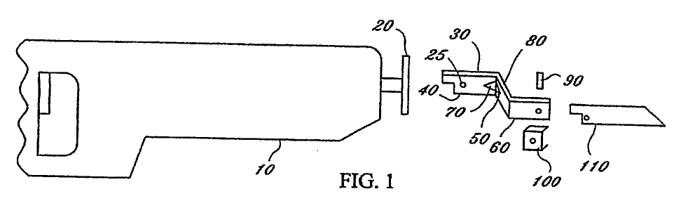

The first metal plane (40) and third metal plane (60) are, at all times, parallel with each other. In the embodiment shown in FIG. 1, the first, second, and third metal planes (40, 50, 60) are shown with a 90-degree connection. Between the first, second, and third metal planes (40, 50, 60) are angle braces (70, 80). These braces are designed to support the offset adapter (30) while still allowing the device to be flexible enough to access angles, which are not normally accessible, by the adapter (30). For example, if the user desires to use standard blade (110) to cut a hole in a wall, but the desired angle of approach to the wall cannot be achieved because of the relatively parallel arrangement of standard blade (110) and power driven saw (10), then angle braces (70, 80) flex to allow the user to engage the wall. In such case, once the user has inserted standard bland (110) into the wall, the user can pull or push the power driven saw (10) so that the angle braces (70,80) flex—that is the angle braces extend and compress—to create the desired angle of approach.

The third metal plane (60) is designed to accept a standard blade (110) in the same fashion as that of the reciprocating drive member (20) by using a conventional set screw (90) and a set screw receiving member (100). Set screw receiving member (100) is a U-shaped piece of metal that sandwiches standard blade (110) when standard blade (110) is held adjacent to third metal plane (60)

Alternative embodiments of the invention are many and varied. The first, second, and third metal planes (40, 50, 60), may be lengthened or shortened depending on the type of power driven saw (10) employed and depending on the additional offset length or reach desired. Further the angles between the first, second, and third metal planes (40, 50, 60) may also be changed in order to allow the user to make cuts at numerous angles. As the adapter (30) is inexpensive to manufacture, and is quite simple in design, many different lengths of first, second, and third metal planes (40, 50, 60) may be provided in a box in much the same fashion as drill bits are conventionally sold.

It should be noted that no matter the format of the adapter (30), it is always able to fit into a conventional power driven saw (10). As aforementioned, in FIG. 1, the standard hole (25) identical to the conventional hole used for locking any reciprocating saw blade into a reciprocating drive member (20) is shown.

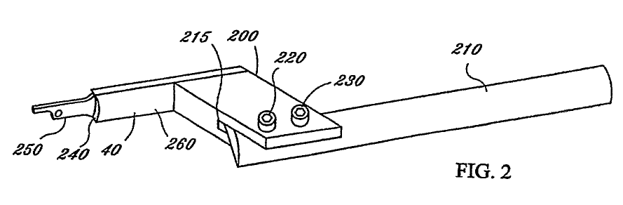

Another embodiment of the present invention has second metal plane (50) and angle braces (70, 80) merged as one piece with greater girth, so that merged together, they appear as a trapezoid (200), as shown in FIG. 2. The trapezoid (200) provides even greater structural integrity than second metal plane (50) and angle braces (70, 80), if no flexing, as aforementioned, is desired. Optionally, trapezoid (200) could be made of a flexible material so that trapezoid (200) bends and ilexes similar to second metal plane (50) and angle braces (70, 80). Trapezoid (200) is conventionally bolted to first metal plane (40).

Another embodiment of the present invention has third metal plane (60) deleted because trapezoid (200) is specially modified to communicate with file (210). This embodiment allows the adapter (30) to hold other implements such as file (210), sanders, or any other device that can fit in slot (215) and be conventionally bolted via first bolt (220) and second bolt (230). Second bolt (230) can be conventionally spring loaded.

An additional embodiment, as shown in FIG. 2, has a curved collar (240) that mates with the internal shape of reciprocating drive member (20) to form a curved fit that better holds first metal plane (40) in place. Preferably, curved collar (240) is a boundary between first section (250) of first metal plane (40) and second section (260) of first metal plane (40), such that first section (250) is narrower than second section (260).

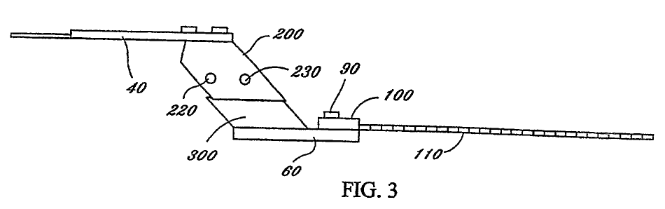

As shown in FIG. 3, another embodiment of the present invention has blade trapezoid (300) that is an extension mounted below and partially within trapezoid (200). This embodiment allows the adapter (30) to hold a standard blade (110) when trapezoid (200) is employed in place of second metal plane (50). Blade trapezoid (300) can fit in slot (215)—shown in FIG. 2—and be conventionally bolted within and to trapezoid (200) via first bolt (220) and second bolt (230). For quick removal, second bolt (230) can be spring-loaded. Blade trapezoid (300) communicates with third metal plane (60), in this embodiment, such that conventional set screw (90) and a set screw receiving member (100) sandwich standard blade (110) when standard blade (110) is held adjacent to third metal plane (60). Trapezoid (200) is held to first metal plane (40) via top fasteners (510). Third metal plane (60) has a bevel (61) on its lower front end, to provide for greater clearances near surfaces.

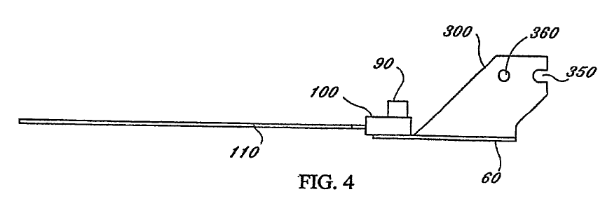

In another embodiment, second bolt (230) can be turned by the user's fingers to move through trapezoid (200) and contact blade trapezoid (300). This is significant because blade trapezoid (300)—as shown in FIG. 4—has first receiving aperture (350) that is merely an arc for receiving first bolt (220), whereas second receiving aperture (360) is actually a hole for receiving second bolt (230). The user can simply slide first receiving aperture (350) on and off first bolt (220) upon engaging and disengaging second receiving aperture (360) with second bolt (230), allowing for a “quick change” operation. Because of this quick change feature, blade trapezoid (300) can be fixed to other common tools such as sanders, files, and the like, in place of standard blade (110) to allow the user to quick change a variety of common tools and affix them to trapezoid (200).

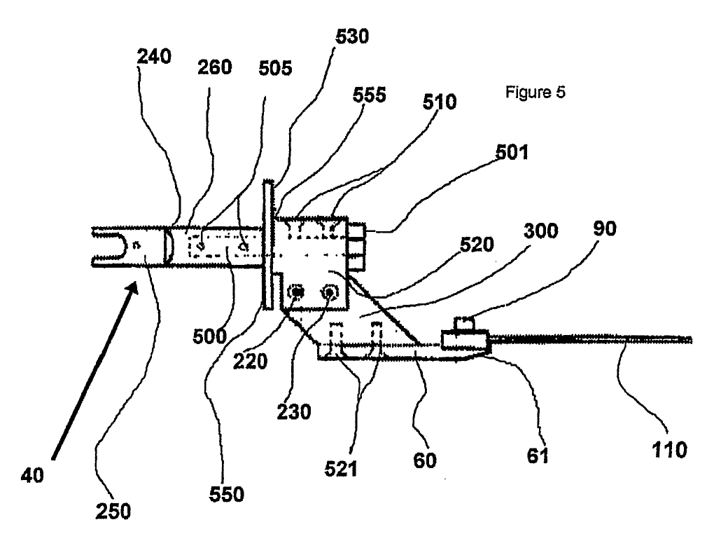

A further alternative embodiment of the present invention allows one or two rotation points in relation to the conventional power driven saw (10). As shown in FIG. 5, this embodiment has a curved collar (240), as in FIG. 2, mating with the internal shape of a conventional reciprocating drive member to form a curved fit that better holds first metal plane (40) in place. The embodiment shown in FIG. 5 also has curved collar (240) as a boundary between first section (250) of first metal plane (40) and second section (260) of first metal plane (40), such that first section (250) is narrower than second section (260)—this is just as in FIG. 2. In the embodiment of FIG. 5, though, first metal plane (40) receives first rod (500) and holds first rod (500) via side fasteners (505), and first rod (500) attaches via top fasteners (510) to be held within block region (520). Trapezoid (200) of FIGS. 2 and 4 is replaced by block region (520) in this embodiment to allow a first point of rotation to occur as further explained below.

Within block region (520), first rod (500) serves as an axis of rotation. Dial (530) is preferably a numeric dial through which first rod (500) passes and to which first rod (500) is fixed, and dial (530) is sandwiched between second section (260) of first metal plane (40) and block region (520) Dial (530) is turned on the threaded end (501) of first rod (500), and when dial (530) has been completed turned to pass over the entire threaded end (501) of first rod (500), dial (530) is fixedly attached to first rod (500) and remains stationary. Alternatively, dial (530) can be simply molded or otherwise conventionally attached to first rod (500).

Lock nut (540) applies pressure to block region (520) because lock nut (540) is tightened on the end of first rod (500). Block region (520) is prevented from rotating about first rod (500) because lock nut (540) applies pressure to fixedly hold it and prevent rotation. While top fasteners (510) do hold block region (520) on first rod (500) to prevent rotation, they are not required because of the pressure applied by lock nut (540).

Optionally, dial (530) has first teeth (550) that communicate with second teeth (555) of block region (520). Use of first teeth (550) and second teeth (555) provides further prevention against bock region (520) moving in relation to first rod (500).

To rotate the present invention, side fasteners (505) are not loosened and/or removed from second section (260) of first metal plane (40)—side fasteners remain against first rod (500) so that first rod (500) does not rotate. The user loosens lock nut (540) from the end of first rod (500), and if top fasteners (510) are being employed, they too are loosened. With lock nut (540) and any top fasteners (510) so loosened, block region (520) is free to rotate about first rod (500). The user rotates block region (520) along with first rod (500), but does so after first teeth (550) are separated from second teeth (560) if first teeth (550) and second teeth (560) are being employed. The separation is possible once lock nut (540) has been loosened so that block region (520) can not only rotate, but move away from dial (530) along first rod (500).

Once block region (520) has been rotated to the position desired by the user, first teeth (550) and second teeth (560), if present, are fitted together as block region (520) is moved along first rod (500) flush against dial (530), and lock nut (540) is tightened. Top fastener s (510), if present, are reattached to block region (520) to hold block region (520) on first rod (500) to prevent rotation of block region (520). Note that bottom fasteners (521) are shown linking blade trapezoid (300) to third metal plane (60).

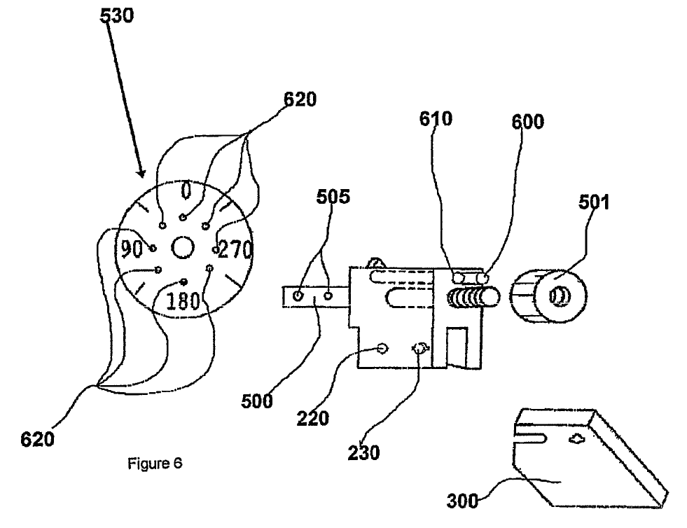

As shown in FIG. 6, another embodiment of the present invention also has dial (530) and block region (520); however, in this embodiment, top fasteners (510)—shown in FIG. 5—are absent and replaced with location pin (600). Pin aperture (610) receives location pin (600), and location pin (600) slides back and forth within pin aperture (610) as lock nut (540) is tightened upon first rod (500).

In operation, when lock nut (540) pushes location pin (600) through pin aperture (610), location pin (600) slides through one of dial apertures (620) to prevent block region (520) from rotating about first rod (500). When lock nut (540) is loosened upon first rod (500), location pin (600) can be pushed with the user's finger so that location pin (600) moves out of one of dial aperture (620) so that block region (520) can rotate about first rod (500). The placement of location pin (600) through pin aperture (610) depends upon how much or how little block region (520) is rotated about first rod (500). Conventional indicia on dial (530) can show the location pin (600) positioning along the dial (530), and thus, the positioning of block region (520) because block region (520) rotates with location pin (600).

In FIG. 6 the first bolt (220) and second bolt (230) fit into first bolt aperture (221) and second bolt aperture (231). The second bolt (230), if spring loaded, fits into second bolt aperture (231), which conventionally receives second bolt (230).

FIG. 7 shows a motorized embodiment of the present invention. In this embodiment, power driven saw (10) is not employed; rather, a rotating power saw (700) is employed that is specially designed as part of the present invention. Rotating power saw (700) is attached to a conventional battery pack (710). A first motor (720) operates a first drive wheel (740) via a conventional first worm type gear (750). A conventional trigger switch (760) conventionally communicates with first motor (720) to allow the user to turn first motor (720) on and off. First drive wheel (740) repeatedly moves arm (760) away from first drive wheel (740) and toward first drive wheel (740) as first drive wheel (740) rotates because first drive wheel (740) is conventionally attached to arm (760). Central block (770) repeatedly moves in concert with arm (760) because central block (770) and arm (760) are conventionally attached to one another. A first mounting bracket (775) holds central block (770) in place while allowing for desired movement towards and away from first drive wheel (740).

A first drive line (780) is, at one end, positioned internal of central block (770). Second motor (790) rotates first drive line (780) via a conventional first spine gear assembly (800). The outer surface of first drive line (780) has conventional first ridges (777) to communicate with first spine gear assembly (800). First drive line (780) is, at its central portion, positioned within second drive line (785) right before first drive line (780) exists central block (770). First bearing (810) allows first drive line (780) to rotate within central block (770), while second bearing (820) allows first drive line (780) to rotate within both central block (770) and second drive line (785). Second drive line (785) continues halfway into quick change chuck (850). Third bearing (830) allows first drive line (780) to rotate within second drive line (785). Second mounting bracket (840) holds third bearing (830) in place. First drive line (780) continues into quick change chuck (850). At the end of first drive line (780) is a female receptacle (781). Female receptacle (781) is utilized to receive male member (782) of third drive line (783).

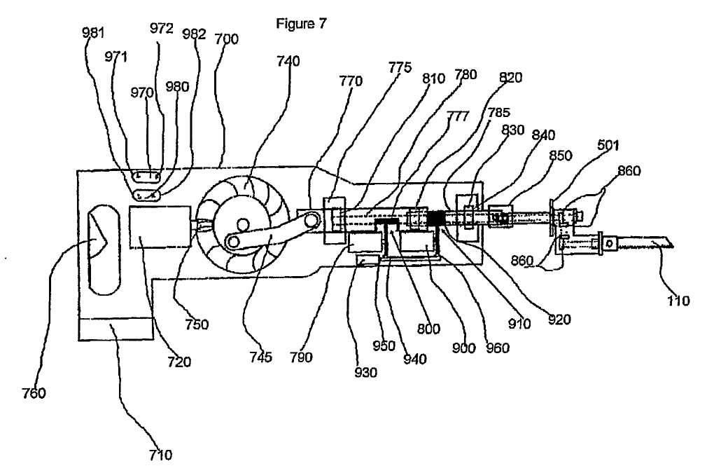

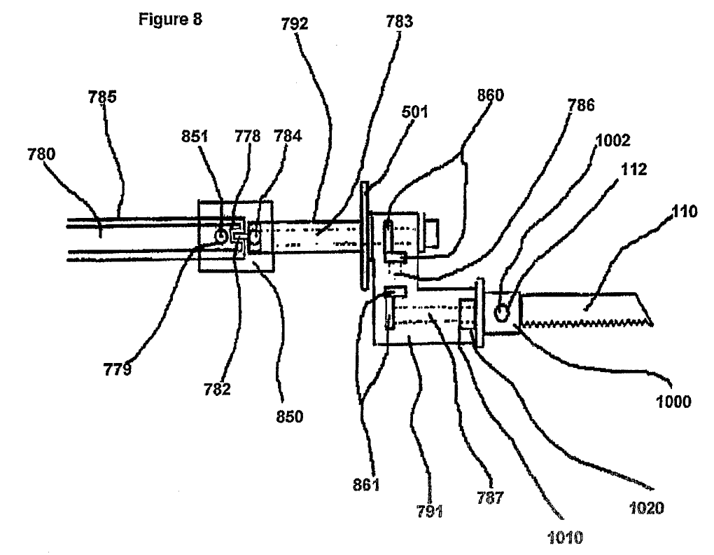

As shown in FIG. 8 through quick change chuck (850), third drive line (783) and second drive line (785) are first chuck aperture (851), third drive line aperture (784) and second drive line aperture (779) to allow a pin to be inserted to secure all pieces together. Third drive line (783) then continues through dial (501) and into housing (791). Housing (791) in previous embodiments was comprised of 3 different pieces, trapezoid (200), blade trapezoid (300) and block region (520). At the end of third drive line is connected to fourth drive line (786) via worm gears (860). Forth drive line (786) is connected to fifth drive line (787) via worm gears (861). Fifth drive line (787) is then connected to blade chuck (1000) via male, female connecters. At the end of fifth drive line (787) is female connector (1010). Female connector (1010) receives male connector (1020), which is on the insertion end of standard blade (110). Blade chuck (1000) and standard blade (110) have second chuck aperture (1002) and blade aperture (112) to allow a pin to be inserted to secure standard blade (110).

Second drive line (785) is, at one end, positioned internal of central block (770). Third motor (900) rotates second drive line (785) via a conventional second spine gear assembly (910). The outer surface of second drive line (785) has conventional second ridges (920) to communicate with second spine gear assembly (910). Second drive line (785) is, at its central portion, positioned within third bearing (830).

Rotation of first drive line (780) and second drive line (785) is prevented via manual lever (930). If the user turns manual lever (930), lever cylinder (940) turns as well because it is fixed to manual lever (930). When lever cylinder (940) turns, first gear interrupter (950) communicates with first spine gear assembly (800). Similarly, when lever cylinder (940) turns, second gear interrupter (960) communicates with second spine gear assembly (910). Thus, when the user has rotated first drive line (780) and second drive line (785) as desired, the user can turn lever cylinder (940) to prevent any movement of first drive line (780) and second drive line (785). To cause first drive line (780) and second drive line (785) to rotate, the user needs to press first switch (970) or second switch (980), respectively. First switch (970) conventionally communicates with second motor (790), which in turn rotates first drive line (780) as aforementioned. Second switch (980) conventionally communicates with third motor (900), which in turn rotates second drive line (785) as aforementioned. First switch (970) and second switch (980) both have an option of polarity to control the clock wise or counter clockwise direction of drive wheel (740). First switch (970) has first left switch (971) and first right switch (972); selecting one of these will cause second motor (790) to respond accordingly. Second switch (980) has second left switch (981) and second right switch (982); selecting one of these will cause third motor (900) to respond accordingly.

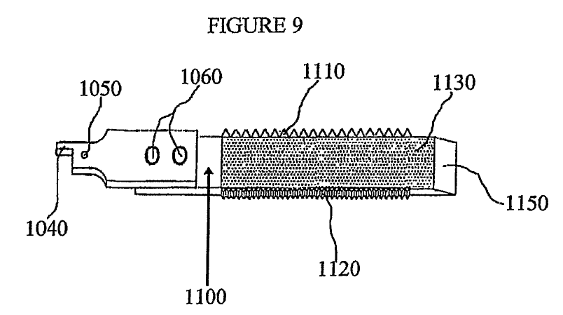

In place of standard blade (110) a “multi-tool” attachment (1100), as shown in FIG. 9, can be attached. Multi tool attachment (1100) has, on first edge (1110), a wood saw, on second edge (1120), a metal saw, on first side (1130), a wood rasp, on second side (1140), a metal rasp/file (not shown) and on the tip (1150), a chisel. Additionally a conventional chisel blade can be attached, and as the conventional chisel comes in many different shapes and sizes so will the conventional chisel blade attachment.

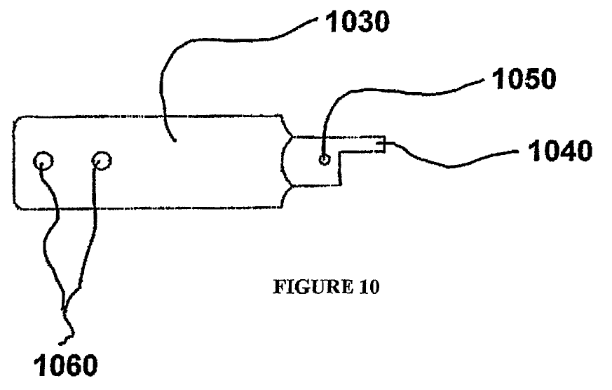

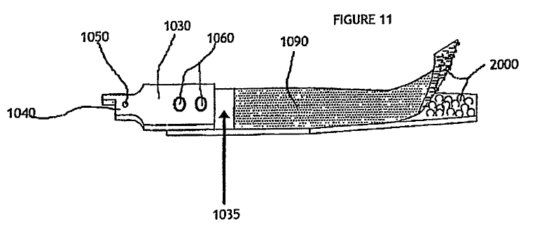

As shown in FIG. 10, an alternative embodiment of the present invention has an extension (1030) that connects the power driven saw (10) to the reciprocating saw blade. The extension (1030) can accommodate all conventional reciprocating saw blades, and is designed to allow the user to use the reciprocating to cut an area that is away from their reach. While the extension (1030) can potentially be 10 feet, stability is an important factor in determining the length of the extension (1030). While the extension (1030) can be longer, the preferred length of the extension (1030) is anywhere from 12-24 inches. The extension (1030)'s insertion point (1040) contains a drill hole (1050) that attaches to the power saw at third metal plane (60) of the offset adapter (30) (not shown in FIG. 10). The extension (1030) further contains two drill holes (1060) that attaches to the reciprocating drive member (20) of the blade. The extension (1030) can also attach to a flat paddle (1035), made of memory plastic, with the capability to interchange abrasive surfaces (such as sandpaper (1090)) utilizing a hook and loop type fastener (2000), as a method of attachment to the extension (1030) (shown in FIG. 11).

As previously stated, it is important that the extension (1030) maintains stability in order to provide adequate support for the standard blade (110), multi tool attachment (1100), conventional chisel or rasp and the sanding paddle (1035). It is equally important for the extension (1030) to maintain durability and to provide reasonable flex while in action. It has been observed that most steel alloys conventional in the art are not durable, stable, or flexible enough to be well suited for an extension (1030) of this caliber. Observation has shown that when a heavier attachment such as the multi tool attachment (1100) conventional rasp or chisel is used in conjunction with extension (1030), when made of the weaker steal, the inertia of the heavier attachment pulls on extension (1030) and in turn snaps extension (1030) rendering it unserviceable. For that reason, it is preferred that the steel be durable and stable enough to withstand the reciprocating action of the power driven saw (10), while maintaining the flex that will allow access to angles which are not normally accessible by an offset adapter (30).

While each one requirement is important, choosing the right steel alloy is a balancing act. For example, steel alloys of a 1095 grade (with 95 carbon content) might be inexpensive, however they do not provide the durability that works best with the present invention. On the other hand, H13 steel is extremely hard, yet is so brittle that it lacks the stability required to operate the present invention. A steel alloy that provides enough durability and stability, while maintaining flexibility that will not bent too easily is required in order for the extension to operate in furtherance of the principles of the present invention, is necessary. Three metals have been conceived in the present invention: S7 (at the recommended hardness of 54 Rockwell), Vanadis #4, and particularly Flexor™ (at the recommended hardness of 48 Rockwell). The steel alloys are oil quenched in order to improve hardness of the alloys. While these alloys work best, the present invention is not limited to the aforementioned steel alloys, and can employ any steel alloy in furtherance of the principles of the present invention.

The entire extension (1030) can be, and is preferred to be, the same alloy throughout. The portion of the extension (1030) at the insertion point (1040) requires a durable and stable metal. However, the rest of the extension (1030) may be a different, cheaper metal that is still durable, stable and flexible, yet not as expensive. While steel alloys of a 1095 grade are not appropriate at the insertion point (1040), the remainder of the extension (1030) may constitute the 1095 grade alloy. However, it may be preferable that the entire extension (1030) maintains the same steel alloy throughout.

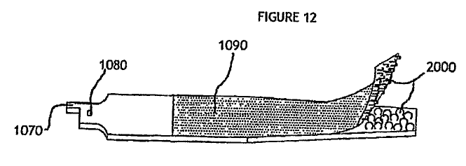

As shown in FIG. 12, an alternative embodiment of the present invention has an in-line or off-set sanding paddle (1035) that attaches to the present invention. The insertion point (1070) of the sanding paddle (1035) has a drill hole (1080) that attaches to either the reciprocating drive member (20) (which causes the paddle to be in-line) or the third metal plane (60) of the offset adaptor (30) (which causes the paddle to be offset). The sanding paddle (1035) can also be attached to the above mentioned extension (1030). The sanding paddle (1035) can also be molded around the key, such that it is permanently affixed to the insertion key (1070). The sanding paddle (1035) contains conventional sanding paper on a first side of the paddle (1090). A second, opposite side (2010) of the sanding paddle (1035) may have steel or any other type of metal in furtherance of the principles of the present invention. The second side (2010) of the sanding paddle (1035) may also be a flexible plastic or rubber material with memory flexes such that the sanding paddle (1035) can flex and form to a particular area, and then return to its manufactured shape. The conventional sanding paper can be affixed to the first side (1090) of the sanding paddle (1035) via glue, clamps, or it can be attached via a hook and loop type fastener (2000), or any type of conventional attachment in furtherance of the principles of the present invention. The preferred embodiment of this hook and loop type fastener (2000) is such that the loop portion is embedded in the plastic portion of the sanding paddle (1035), such that there is no deterioration of the conventional sanding paper involved in affixing the hook and loop type fastener (2000). In an alternate embodiment first and second sides (1090 and 2010) of the sanding paddle (1035) are covered in one strip of conventional sanding paper by being attached to the first side (1090) then folding over the tip and attaching to the second side (2010). This method is desirable for two reasons. First having the conventional sanding paper fold over the tip allows the user to reach places at different angles not possible when the tip is not covered. And second, with the rapid motion of the sanding paddle (1035) with the conventional sanding paper attached to first or second side (1090 and 2010) it is possible for the conventional sanding paper to gradually be removed requiring the user to manually reaffix the conventional sanding paper. Having the conventional sanding paper fold over the tip provided a more stable attachment and it is less likely to come off. Other alternate embodiments would include different shaped sanding paddles (1035) such as a circle to cover more surface area and triangles in different positions to reach different corners, however many other shapes and sizes can be applied.

Another embodiment for the sanding paddle (1035) is a plastic sleeve capable of fitting onto the existing attachment (i.e. standard blade (110) or conventional rasp or chisel) and snapping into place for quick use of both attachments.

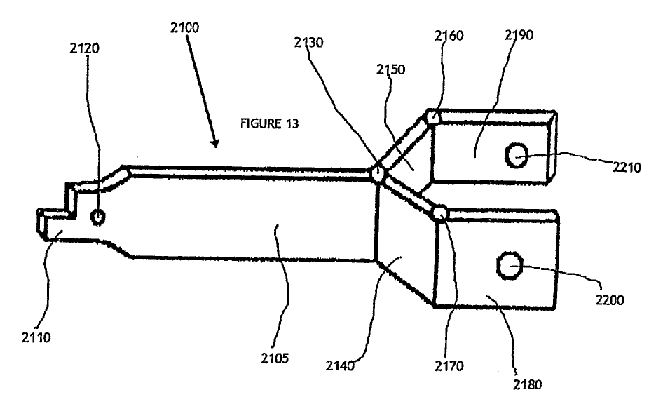

To employ the use of more than one of any reciprocating saw attachment (i.e. standard blade (110), conventional rasp or chisel, or the multi tool attachment (1100), an adjustable multiple attachment system (2100) is used. As shown in FIG. 13, an adjustable multiple attachment system (2100) allows at least two standard blades (110), two multi tool attachments (1100), or two sanding paddles (1035) to be attached to one reciprocating saw to be used simultaneously. The insertion point (2110) is the same as all attachments with a drill hole (2120). The multiple attachment system (2100) has base member (2105) extends 2″-3″ until it forks at first adjustable hinge (2130). Adjustable hinge (2130) allows first adjusting arm (2140) and second adjusting arm (2150) to adjust the width between the two standard blade (110) or sanding paddle (1035) attachments. On the opposite ends of first and second adjusting arms (2140 and 2150) are second adjustable hinge (2160) and third adjustable hinge (2170). Second and third adjustable hinges (2160 and 2170) allow third adjusting arm (2180) and fourth adjusting arm (2190) to adjust the Z-axis angle of the blade or paddle attachments. The blade or paddle attachments clamp onto the ends of third and fourth adjusting arms (2180 and 2190) at first attachment fastener (2200) and second attachment fastener (2210). Each of the adjustable hinges (2130,2160 and 2170) and the attachment fasteners (2200 and 2210) are all controllable by a conventional thumb screw.

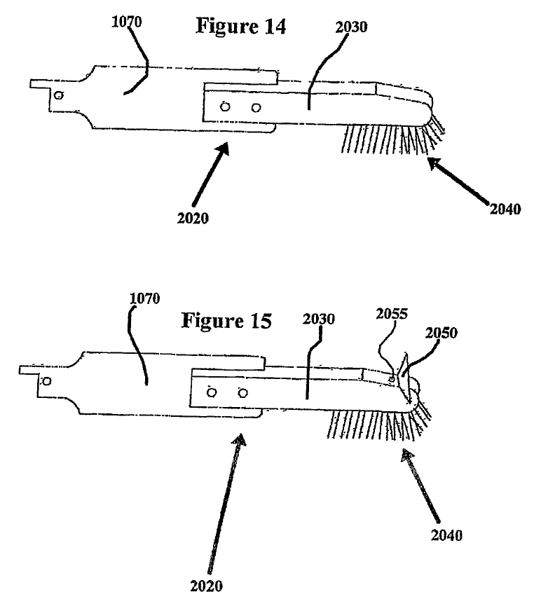

As shown in FIG. 14, an alternative embodiment of the present invention has a wire brush (2020) that attaches to the present invention. The insertion point (1070) of the wire brush (2020) has a drill hole (1080) that attaches to either the reciprocating drive member (20) or the third metal plane (60) of the offset adaptor (30). The wire brush (2020) can also be attached to the above mentioned extension (1030). The main body (2030) of wire brush (2020) can be made of a flexible plastic or rubber material with memory flexes such that the wire brush (2020) can flex and form to a particular area, and then return to its manufactured shape. The main body (2030) of wire brush (2020) can also be made of a wood or metal to provide rigid support for better control while in use. The bristles (2040) of wire brush (2020) can be made of stiff wire such as copper, steel or a steel alloy, but must remain rigid so as to be able to brush away rusty surfaces or stubborn paint. Wire brush (2020) can be affixed to the insertion key (1070) in such a manner as would a conventional knife blade be inserted into its handle as the knife's tang, or any type of conventional attachment in furtherance of the principles of the present invention. Another alternate embodiment as shown in FIG. 15 the wire brush (2020) would have a scraper (2050) attached to the tip of main body (2030) at an angle, preferably 45 degrees, and fastened preferably with a conventional screw (2055). Scraper (2050) can be, but is not limited to, in the shape of a trapezoid.

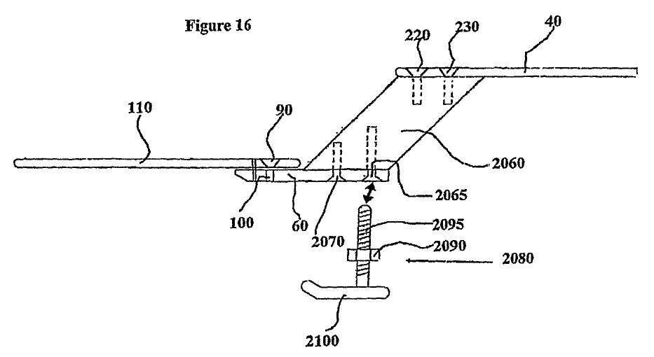

In FIG. 16 the eighth embodiment of the present invention is shown. This particular embodiment is similar to the third embodiment of the present invention with a few minor differences. First metal plane (40) attaches to parallelogram (2060) via first and second bolts (220 and 230). Attached to the opposite side of parallelogram (2060) is third metal plane (60) via third bolt (2070) and guide foot assembly (2080) (explained in detail later). At the end of third metal plane (60) is attached blade (110) via conventional set screw (90) and set screw receiving member (100). Parallelogram (2060) is one solid piece of metal. Guide foot assembly (2080) serves two purposes; first, it is used to secure third metal plane (60) onto parallelogram (2060) and second, it is used to guide and distance blade (110) from a surface while making a cut so as not to damage it. As the guide foot assembly (2080) creates distance between surfaces it is adjustable. Adjusting nut (2090) rotates up and down bolt (2095). When bolt (2095) is inserted through third metal plane (60) and into parallelogram (2060) via aperture (2065) adjusting nut (2090) will sit flush against third metal plane (60). Depending on the position of adjusting nut (2090) will determine the distance that guide foot assembly (2080) will stick out from third metal plane (60) and in turn determine the distance in which blade (110) will be from the surface below it. Guide (2100) is curved upward in the front so as to allow the surface that guide (2100) comes in contact with to pass underneath without obstructing the path of guide (2100) and without damaging the surface.

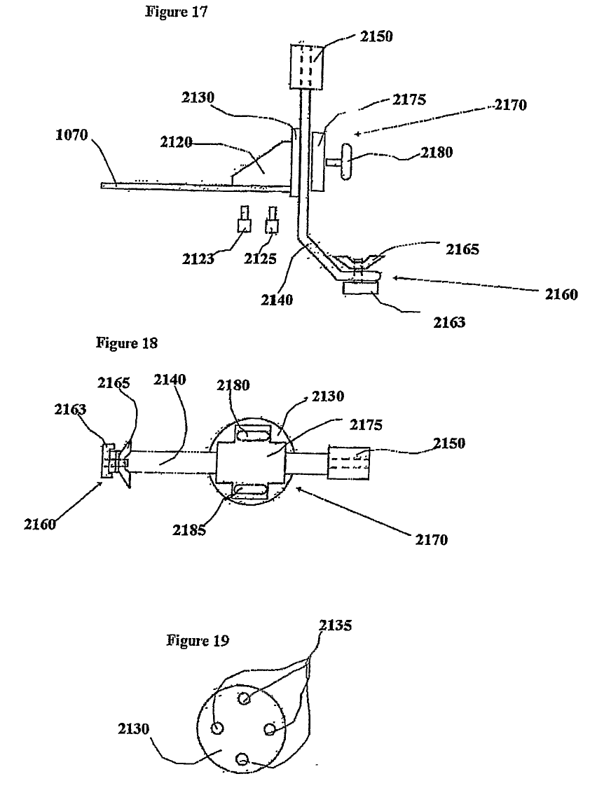

Shown in FIG. 17, is an alternative embodiment of the present invention. The adjustable rotating flush cut adapter (2110) is used to allow for offset cuts and angled offset cuts. The adjustable rotating flush cut adapter (2110) has an insertion key (1070) attached to a mounting bracket (2120) via conventional set screws (2123 and 2125). Fixedly attached to the mounting bracket (2120) by any conventional means is dial (2130). Dial (2130) has four apertures (2135) (shown later in FIG. 19). The weighted adjustable arm (2140) is adjusted about the center axis of dial (2130). At the top of the weighted adjustable arm (2140) is an adjustable weight (2150). The weight (2150) is adjusted by rotating the weight (2150) around threads up or down to balance the adjustable arm (2140). At the bottom of the adjustable arm (2140) is blade clamp assembly (2160) having a conventional bolt (2163) and conventional wing-nut (2165). On the opposing side of the adjustable arm (2140) from the dial (2130) is locking device (2170) having a housing (2175), first locking pin (2180) and second locking pin (2185) (second locking pin (2185) shown in FIG. 18). The dial (2130) allows the adjustable arm to rotate 90 degrees at a time and a total of 360 degrees and lock in place as the first locking pin (2180) and second locking pin (2185) insert into apertures (2135).

As shown in FIG. 18 the adjustable rotating flush cut adapter (2110) is rotated 90 degrees to the left. Additionally the figure shows the second locking pin (2185).

FIG. 19 shows the dial (2130) with four apertures (2135).

FIG. 20 shows a once piece rasp (2190) having an insertion key (2200) and a main body (2210). One piece rasp (2190) is preferably stamped out of 10-95 coil stock steel.

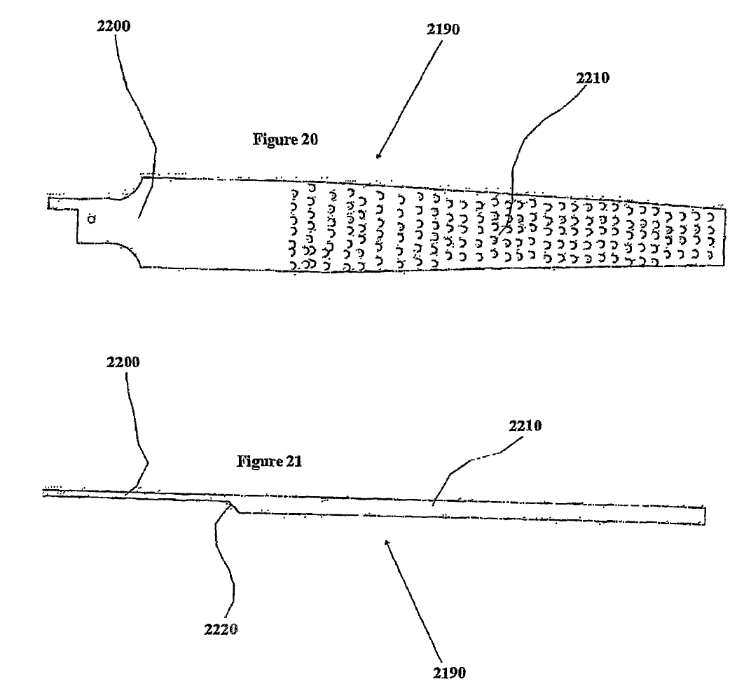

FIG. 21 shows the one piece rasp (2190) form the side. Approximately 2 inches from the tip of insertion key (2200) is a bevel (2220) to allow the insertion key (2200) to be thin enough to fit into a conventional reciprocating saw but allowing the main body (2210) of the one piece rasp (2190) to be thick enough so as not to snap.

In FIG. 22 a stabilization device is shown. This embodiment has two purposes. First, the stabilization device (2230) stabilizes the adapter (2250) that is attached to the reciprocating saw (2240). Second, the guide (2260) measures the point of impact of the blade and eliminates uncontrolled movement. The attaching band (2270) wraps around the front for the saw (2240) and is tightened by the tightening device (2280) having set screw (2290) within the first set screw receiving member (2295) and second set screw receiving member (2300). The tightening device (2280) is located on top of the saw (2240). Located on either the left or right side of the saw (2240) is rod clamp (2310) having a conventional thumb screw (2315) for tightening and a housing (2320) with an aperture (2325) to receive the stabilizing rod (2330). Also on stabilizing rod (2330) is guide (2260). Guide has an aperture (not shown) that receives the stabilizing rod (2330) to allow the guide (2260) to move freely along stabilizing rod (2330). The guide (2260) is also mounted on the attachment (2250) to allow the attachment (2250) to control the movement of the guide (2260) along the stabilizing rod (2330) and ultimately attaches the stabilizing rod (2330) to the attachment (2250) to provide stability.

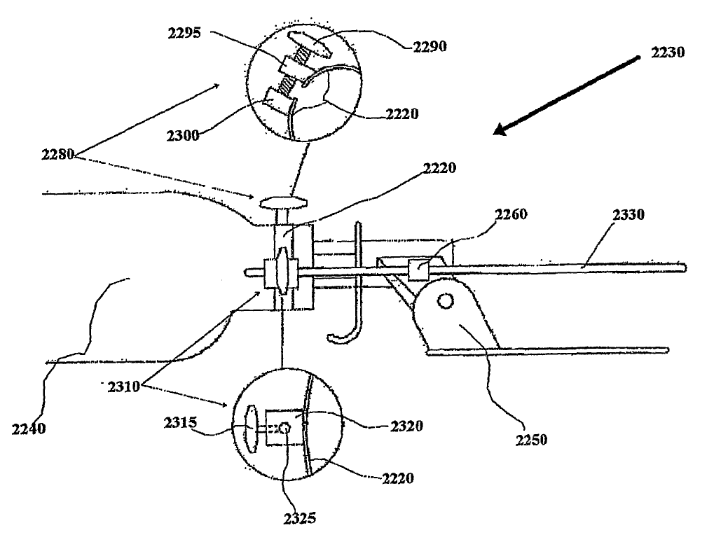

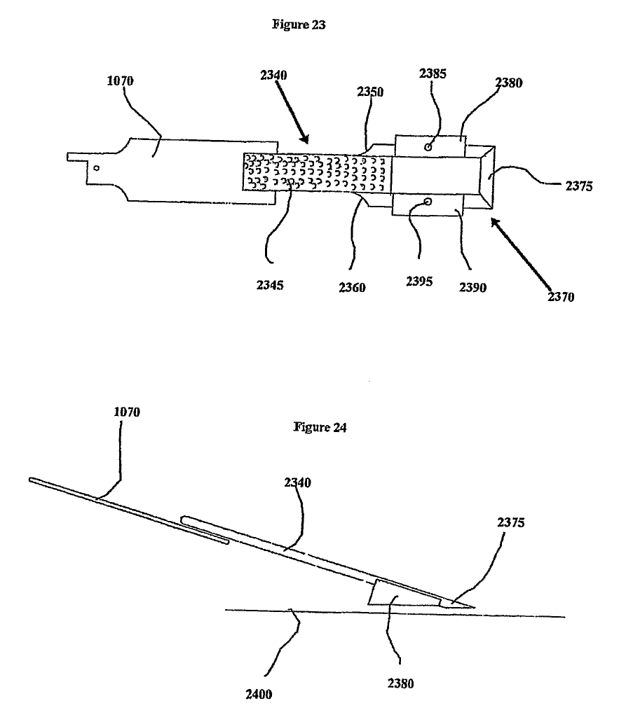

An eleventh embodiment of the present invention is shown in FIGS. 23 and 24. In FIG. 23 a chisel with guide adapter is shown. Attached to insertion key (1070) is main body (2340). Main body (2340) can be a rasp, a inter-changeable sanding paddle with hook and loop fasteners. Half way across main body (2340) starts chisel head (2370) with bevels (2350 and 2360) to provide clearance for the main body (2340) when in use. The surface area (2345) of the chosen tool on main body (2340) begins at the end of the insertion key (1070) and ends just past bevels (2350 and 2360). Just after the surface area (2345) on main body (2340) are attached, via first set screw (2385) and second set screw (2395), first depth guide (2380) and second depth guide (2390). First depth guide (2380) and second depth guide (2390) are metal wedges angled to match the angle of the blade (2375) of the chisel head (2370) to act as a guide for the present invention while in use. First and second depth guides (2380 and 2390) will eliminate uncontrolled movement of the present invention. In an alternate embodiment first depth guide (2380) and second depth guide (2390) are attached to each other via a connection piece located on the opposite side of the main body (2340) acting as a one piece clamp. This one piece clamp is attached via conventional pressure screws in place of conventional set screws (2385 and 2395). The conventional pressure screws thread into the clamp and apply pressure to main body (2340) and when loosened allow the clamp to move freely as to adjust the depth of the cut desired by the user.

FIG. 24 shows the position of the first and second depth guides (2380 and 2390) as it impacts the surface (2400), (second depth guide (2390) is not shown, but is a minor image of first depth guide (2380)).

In FIG. 25 a laser projection device with a level is shown. To attach the present invention, band (2410) wraps around the front for the saw (2420) and is tightened by the tightening device (2430) having set screw (2435) within the first set screw receiving member and second set screw receiving member (not shown). The tightening device (2430) is located on side of the saw (2240). Located on the top of the saw (2420) is laser clamp (2440) having a conventional thumb screw (2450) for tightening and a housing (2460) with a laser projector mounted inside (laser projector not shown). The laser projector projects a laser beam (2470) to act as a reference point to guide the user while operating the present invention. Laser beam (2470) can be projected as a dot on the chosen surface or as a solid line from the present invention to the chosen surface. A level bubble (2480) is attached to saw (2420) to provide the user with the capability to project the laser beam (2470) along a level plain to increase the preciseness of the cut. Additionally, when using an offset adapter with the saw (2420), the laser clamp (2450) will need to be mounted on the side of the saw (2420) and the tightening device (2430) mounted on the top of saw (2420).

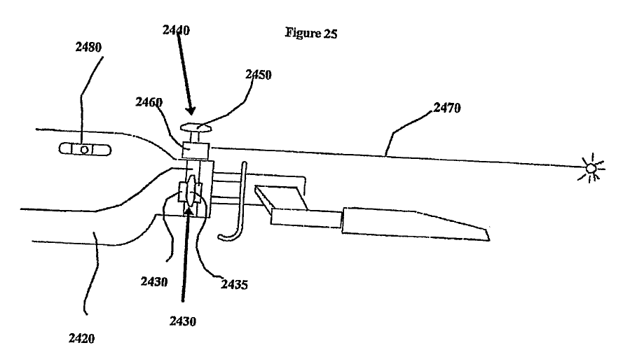

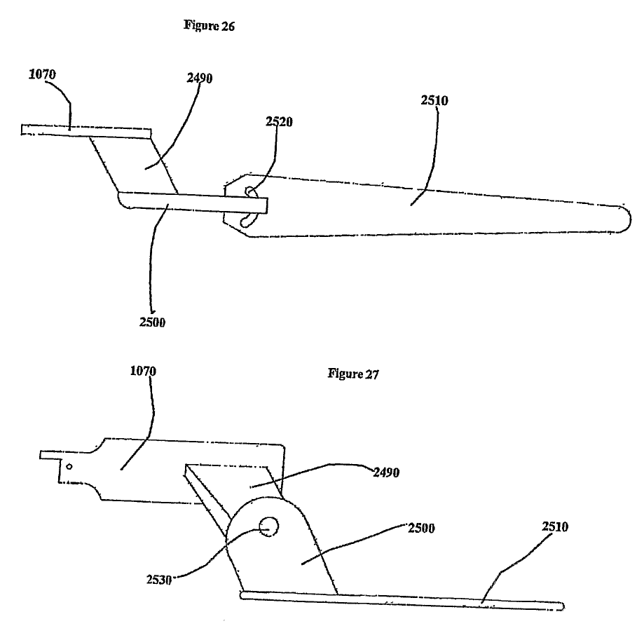

FIG. 26 shows a sanding paddle with multiple offsets and adjustable points of interest. The present invention has an insertion key (1070) to allow the present invention to be attached to a reciprocating saw. Attached to insertion key (1070) via two conventional set screws is metal parallelogram (2490). Metal parallelogram (2490) creates the offset attribute of the present invention. On the opposite end of metal parallelogram (2490) is first metal plane (2500). First metal plane (2500) rotates left to right on an x-axis (shown in greater detail in FIG. 27) allowing the adjustable sanding paddle (2510) the ability to reach many areas at many different angles that a non adjustable sanding paddle cannot. At the end of first metal plane (2500) is where the adjustable sanding paddle (2510) is located. On the adjustable sanding paddle (2510) where it meets with the first metal plane (2500) is the adjusting arch (2520). Archuate in shape the adjusting arch (2520) allows adjustable sanding paddle (2510) to adjust up and down on a y-axis. This function further allows the adjustable sanding paddle (2510) the ability to reach many areas, at many different angles that a non adjustable sanding paddle cannot. The adjustable sanding paddle (2510) is attached to first metal plane (2500) via conventional means so that adjustable sanding paddle (2510) can be tightened, loosened and removed at the users' discretion.

FIG. 27 shows in greater detail the rotation ability of first metal plane (2500) on the bottom of metal parallelogram (2490). First metal plane's (2500) rotating ability is obtained via rotation axis (2530). Rotation axis (2530) is a conventional set thumb screw that is received by a fitted set screw receiver within the bottom of metal parallelogram (2490),

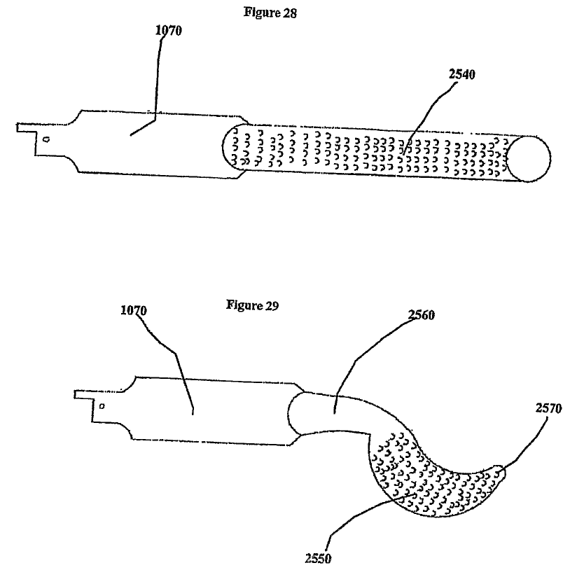

FIG. 28 is a rasp adapter for a reciprocating saw. Made of two pieces of steel molded together the present invention has an insertion key (1070) and a main body (2540). Main body (2540) is a solid steel cylinder rasp having coarse teeth placed completely around the cylinder.

FIG. 29 is a rasp adapter specially created for a particular type of mill work. Made of two pieces of steel molded together the present invention has an insertion key (1070) and a main body (2550). Main body (2550) has a unique shape best described as spoon shaped. Having convex and concave sides, the main body (2550) curves down from the neck (2560) at a 45 degree angle, and curves back upward into a point (2570) much like a conventional spade shovel. Neck (2560) can be made of memory plastic so that it can flex during use.

It should be noted that insertion keys (1070, 2200) can be made of tungsten steel to further strengthen them, preventing breakage.

It should be additionally noted that, applicable to all rasp attachments, the metal composition of each rasp should be ≧42 rockwell and ≦49 rockwell. Reasons for such specifications are <42 rockwell the metal is too soft for high speeds and becomes more malleable >49 rockwell the metal is too brittle for high speeds and will snap easily. Additionally on all rasp embodiments or embodiments with rasps it should be noted that the direction of the rasp teeth should be pointed toward the tip and away from the user. This is necessary for two reasons. Conventionally on a hand rasp the teeth are pointed toward the user because the most power comes from the user pulling on the rasp. Although the reciprocating saw applies equal power on both pulling and pushing strokes it is more likely that the attachment will gradually remove itself from the reciprocating saw. Also if there is more resistance as the attachment is retracting it is more likely that damage of the attachment can occur.

The following is a list of tools that can be attached in place of standard blade (110):
Rod Saw Blade
Coping Saw Blade
Hacksaw Blade
cross cut saw
rip saw
jig saw
back saw
compass saw
panel saw
flooring saw
tenon saw
pad saw
bow saw and bow connection
coping saw
log saw
log saw double sided for connection to two sawzalls
spiral cut saw
scissor pull cutter with brace
key hole saw
drywall saw
Rasps & Files—all metal and wood types
Buffers & Sanders—all short and long handle types

Some of the aforementioned tools, which can be used in place of standard blade (110), may require conventional adaptors.

It should be understood that the rasps, sanders, and other attachments aforementioned for offset use are also similarly effective and novel for use in an inline reciprocating tool.

The present invention is not limited to the embodiments aforementioned, but encompasses any and all embodiments within the scope of the following claims.

I claim:

1. A sanding paddle attachment for a reciprocating saw, comprising:
an insertion key;
a paddle in communication with said insertion key;
a fastener in communication with said paddle; and
sand paper.

2. The device of claim 1, wherein said paddle can be many different shapes and sizes.

3. The device of claim 1, wherein said fastener can be anyone of the following; hook and loop, glue, clamps or any other conventional adhesive.

4. The device of claim 1, wherein said sandpaper is any grad of coarseness.

5. An adapter for a reciprocating drive unit, comprising:
an insertion key;
a main body in communication with said insertion key;
a chisel head in communication with said main body; and
two guides in communication with said chisel head.

6. The device if claim 5, wherein said main body can have a rasp pattern stamped into it.

7. The device of claim 5, wherein said main body can have sand paper attached via hook and loop fasteners.

8. The device of claim 6, wherein said sand paper is replaceable.

9. The device of claim 5, wherein said two guides are wedge in shape.

10. The device of claim 5, wherein said two guides are attached via at least one set screw each.

11. The device of claim 5, wherein said two guides can be any size.

12. An adapter for a reciprocating drive unit, comprising:
an insertion key;
a main body in communication with said insertion key;
a chisel head in communication with said main body; and
at least one guide in communication with said chisel head.

13. The device if claim 12, wherein said main body can have a rasp pattern stamped into it.

14. The device of claim 12, wherein said main body can have sand paper attached via hook and loop fasteners.

15. The device of claim 13, wherein said sandpaper is replaceable.

16. The device of claim 12, wherein said at least one guide is wedge in shape.

17. The device of claim 12, wherein said at least one guide slides onto said chisel.

18. The device of claim 12, wherein said at least one guide is attached via at least one pressure screw.

19. The device of claim 18, wherein said at least one pressure screw is threaded through said at least one guide and applies pressure to said main body, thus tightening said at least one guide onto said main body.

20. The device of claim 12, wherein said at least one guide is adjustable.

21. The device of claim 12, wherein said guide can be any size.

22. A sanding paddle with multiple offsets and adjustable points of interest, comprising:
a insertion key;
a first plane member in communication with said insertion key;
a second plane member in communication with said first plane member; and
a paddle in communication with said second plane member.

23. The device of claim 22, wherein said first plane member is a parallelogram.

24. The device of claim 22, wherein said first plane member is in communication with said insertion key via at least one conventional set screw.

25. The device of claim 22, wherein said second plane member is communication with one conventional set screw.

26. The device of claim 22, wherein said second plane member rotates about said one set screw.

27. The device of claim 22, wherein said paddle pivots at the end of said second plane member via conventional means.

28. The device of claim 26, wherein said paddle pivots at the end of said second plane member via conventional means.

29. The device of claim 22, wherein abrasive paper is in communication with said paddle via a conventional fastener.

30. An adapter for a reciprocating drive unit, comprising:
an insertion key; and
a main body in communication with said insertion key.

31. The device of claim 30, wherein said main body is a cylindrical rasp.

32. The device of claim 30, wherein said insertion key is made of steel.

33. The device of claim 30, wherein said main body is made of steel.

34. The device of claim 30, wherein said insertion key and said main body are molded together to form on piece.

35. An adapter for a reciprocating drive unit, comprising:
an insertion key; and
a main body in communication with said insertion key;
wherein said main body is spade shaped rasp.

36. The device of claim 35, wherein said spade shaped rasp has at least one coarse side.

37. The device of claim 35, wherein said main body has a convex side.

38. The device of claim 35, wherein said main body has a concave side.

39. The device of claim 36, wherein said main body has a convex side.

40. The device of claim 36, wherein said main body has a concave side.

41. The device of claim 37, wherein said main body has a concave side.

42. The device of claim 39, wherein said main body has a concave side.

43. The device of claim 35, wherein said insertion key and said main body are molded together to form on piece.
